(19) United States
(12) Patent Application Publication
(10) Pub. No.: US 2019/0164390 A1
(43) Pub. Date: May 30, 2019

(54) COMMODITY INFORMATION INPUT APPARATUS

(71) Applicant: TOSHIBA TEC KABUSHIKI KAISHA, Tokyo (JP)

(72) Inventor: Tsuyoshi GOTANDA, Ota Tokyo (JP)

(73) Assignee: TOSHIBA TEC KABUSHIKI KAISHA, Tokyo (JP)

(21) Appl. No.: 16/196,552

(22) Filed: Nov. 20, 2018

(30) Foreign Application Priority Data
Nov. 24, 2017 (JP) 2017-226014

(51) Int. Cl. G07G 1/00; G06Q 20/20

(52) U.S. Cl. CPC G07G 1/0018; G06Q 20/208

(57) ABSTRACT

A a commodity information input apparatus includes an input device configured to receive input of commodity information through an operation executed by an operator, a computer configured to identify the operator; calculate a recommended height from a reference plane to the input device based on parameters relating to physical characteristics set for the operator identified by the computer; and adjust a position of the input device so that the height from the reference plane to the input device is equal to the recommended height calculated by the computer.

### CROSS-REFERENCE TO RELATED APPLICATION

This application is based upon and claims the benefit of priority from Japanese Patent Application No. P2017-226014, filed Nov. 24, 2017, the entire contents of which are incorporated herein by reference.

### FIELD

Embodiments described herein relate generally to a commodity information input apparatus.

### BACKGROUND

An input device for inputting information relating to a commodity that a customer purchases includes a keyboard, a touch panel, a scanner and the like. In many retail stores, a commodity information input apparatus constituted by integrally attaching each of these input devices to a suitable position of a housing thereof is used. Generally, the commodity information input apparatus is installed on a work table called a checkout counter. Then, a store clerk in charge of checkout takes one commodity that the customer purchases at a time, and holds a barcode attached to the commodity over a reading window of a scanner to input commodity information thereof. However, for commodities with no barcode like fresh food etc., the store clerk needs to operate the keyboard or the touch panel to input the commodity information.

In this way, an operator of the commodity information input apparatus takes one commodity that the customer purchases at a time, and operates the input device to input the commodity information thereof. For this reason, in a busy period in which many commodities are handled in a short time, physical burden on the operator is large, and thus, for example, the arms, the eyes, etc. are tired. Such a physical burden may be improved by adjusting a position of the input device in consideration of physical characteristics of the operator such as a height of the shoulder, a length of the arm, a height of the eyes, etc.

Thus, a conventional liftable checkout counter in which a height position of the work table can be adjusted is developed. However, since the height position of the work table is manually adjusted in the liftable checkout counter, a burden caused by adjustment job is large. If another operator changes the height, there is a problem that the height position has to be adjusted again.

On the other hand, there is also known a technology of detecting the height of the operator with a height detection sensor to adjust the position of the input device according to the detected height. However, with such a technology, there is a risk that the height cannot be correctly detected depending on a position where the operator stands. If the height cannot be correctly detected, it is difficult to realize an optimum operation environment for the operator.

### DESCRIPTION OF THE DRAWINGS

FIG. 1 is a block diagram schematically illustrating a semi-self-service type POS system;

FIG. 2 is a perspective view illustrating an external appearance of a vertical scanner apparatus functioning as a registration apparatus;

FIG. 3 is a schematic diagram illustrating a state of the vertical scanner apparatus;

FIG. 4 is a block diagram illustrating a circuit configuration of main portions of the vertical scanner apparatus;

FIG. 5 is a schematic diagram illustrating a main data structure of a store clerk record stored in a store clerk database;

FIG. 6 is a schematic diagram illustrating a main memory area of a main memory of the vertical scanner apparatus;

FIG. 7 is a flowchart depicting procedures of a main information processing executed by a processor of the vertical scanner apparatus by executing a control program;

FIG. 8 is a schematic diagram illustrating an example of a change confirmation screen displayed on a touch panel of the vertical scanner apparatus;

FIG. 9 is a schematic diagram illustrating an example of a questionnaire screen displayed on the touch panel of the vertical scanner apparatus;

FIG. 10 is a schematic diagram illustrating an example of a setting table according to a second embodiment; and

FIG. 11 is a flowchart depicting a part of a main information processing performed by a vertical scanner apparatus processor by executing a control program according to the second embodiment.

### DETAILED DESCRIPTION

In accordance with at least one embodiment, a commodity information input apparatus comprises an input device configured to receive input of commodity information through an operation executed by an operator; an identifying module configured to identify the operator; a calculation module configured to calculate a recommended height from a reference plane to the input device based on parameters relating to physical characteristics set for the operator identified by the identifying module; and an adjustment module configured to adjust a position of the input device so that the height from the reference plane to the input device is equal to the recommended height calculated by the calculation module.

Hereinafter, several embodiments of a commodity information input apparatus that can reliably realize an optimum operation environment for an operator without increasing burden on the operator are described with reference to the accompanying drawings.

In the several embodiments, a vertical scanner apparatus functioning as a registration apparatus in a semi-self-service type POS (Point Of Sales) system is exemplified as the commodity information input apparatus. There is a face-to-face type POS system, a self-service type POS system, a semi-self-service type POS system, and the like. In the face-to-face type POS system, a store clerk performs a registration operation of a commodity to be purchased by a customer and a checkout operation relating to settlement of a price of the purchased commodity. In the self-service type POS system, the registration operation and the checkout operation are operated by a customer. In the semi-self-service type POS system, the store clerk performs the registration operation with a registration apparatus, and a customer performs the checkout operation with a checkout apparatus.

### First Embodiment

First, a semi-self-service type POS system is briefly described.

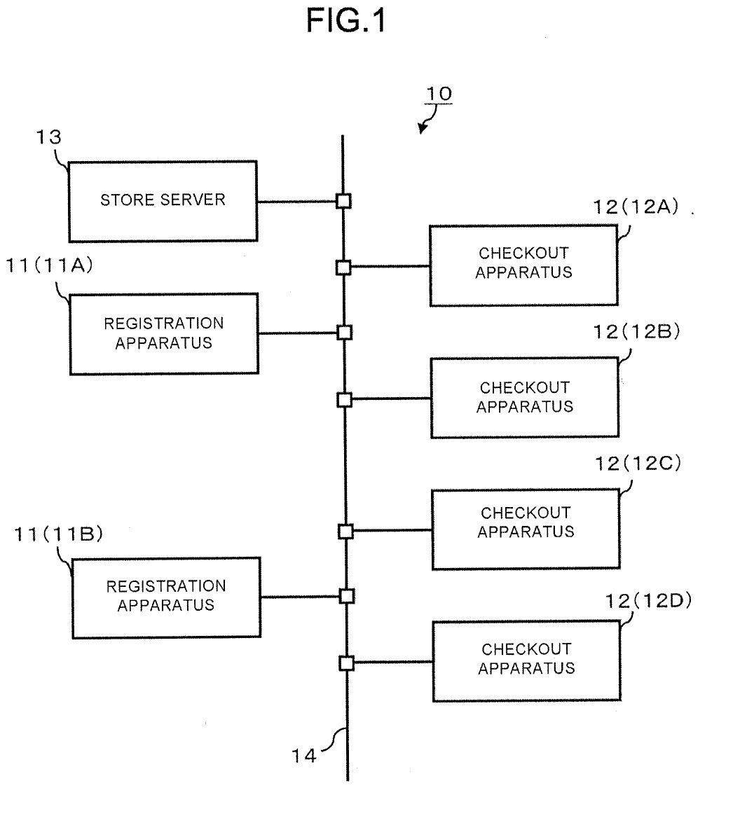

FIG. 1 is a block diagram schematically illustrating a semi-self-service type POS system 10. The POS system 10 includes a plurality of registration apparatuses 11, a plurality of checkout apparatuses 12 the number of which is larger than that of the registration apparatuses 11, and a store server 13. Each of the registration apparatuses 11, each of the checkout apparatuses 12 and the store server 13 are connected to each other via a network 14. The network 14 maybe a wired LAN (Local Area Network)) or a wireless LAN. Alternatively, it may be a network of another communication system.

In FIG. 1, two registration apparatuses 11 (11A, 11B) and four checkout apparatuses 12 (12A, 12B, 12C, 12D) are illustrated. One registration apparatus 11A and two checkout apparatuses 12A and 12B are arranged in one checkout lane, and the other registration apparatuses 11B and the other checkout apparatuses 12C and 12D are arranged in another checkout lane.

Basically, the POS system 10 having such a configuration creates a purchase list for a customer in the registration apparatus 11A based on commodity information input through a registration operation on the registration apparatus 11A performed by a store clerk. Since the purchase list is transmitted to one of the checkout apparatuses 12 arranged in the same checkout lane via the network 14, the customer moves to the checkout apparatus 12 to perform a payment operation for price of the commodity. By such an operation, in the checkout apparatus 12, a settlement processing of a commercial transaction is performed.

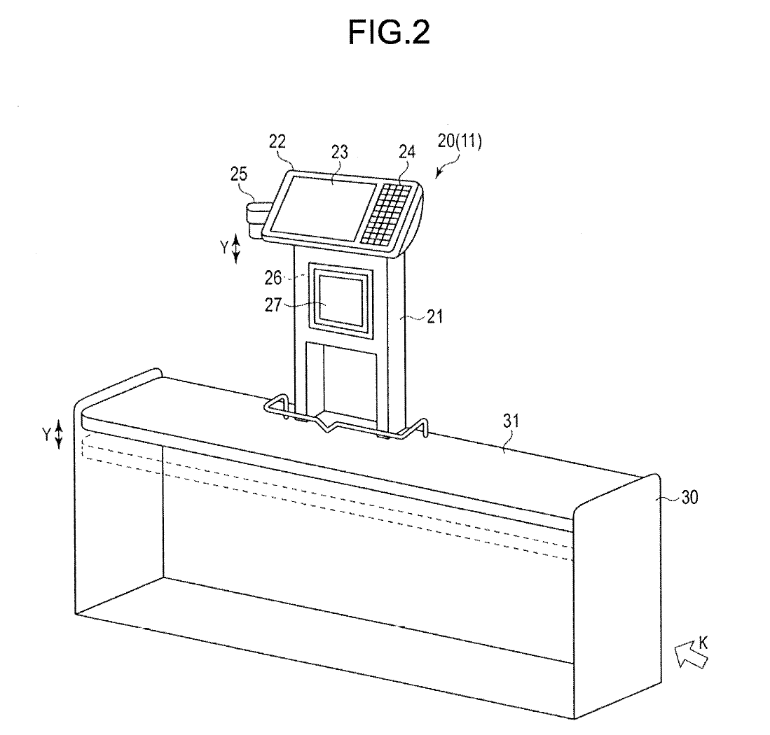

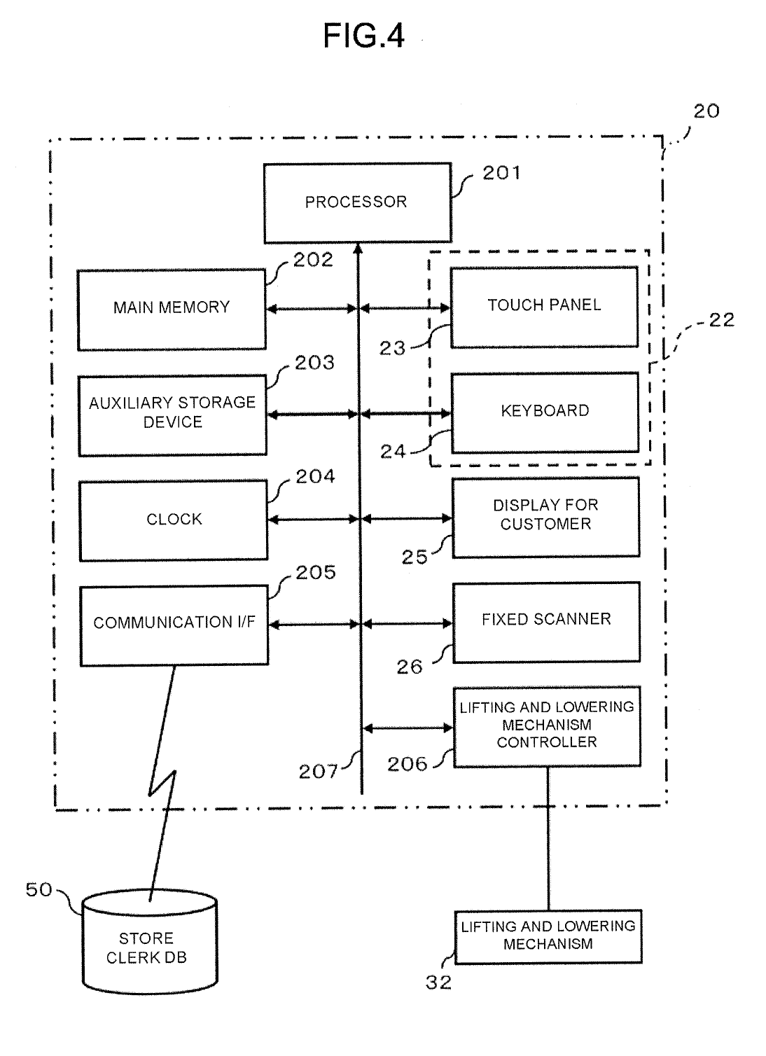

FIG. 2 is a perspective view illustrating an external appearance of a vertical scanner apparatus 20 functioning as the registration apparatus 11. As shown in FIG. 2, the vertical scanner apparatus 20 is fixed to a work table 31 of a checkout counter 30. The checkout counter 30 has an automatic lifting and lowering mechanism 32 (refer to FIG. 4), and the lifting and lowering mechanism 32 can lift and lower the work table 31 in a direction perpendicular to a floor surface 40 (direction indicated by an arrow Y in FIG. 2). The lifting and lowering mechanism 32 is not particularly limited. For example, it may be of an electric motor type, a linear motor type, a hydraulic type or the like.

The floor surface 40 is a space where a store clerk who is an operator of the vertical scanner apparatus 20 stands. A floor surface opposite to the floor surface 40 across the checkout counter 30 is a customer passageway of the checkout lane. The customer who performs checkout of a purchased commodity moves in a direction indicated by an arrow K along the customer passageway.

In the vertical scanner apparatus 20, a flat housing 21 is erected near the center of the work table 31 on a customer passageway side, and an operation panel 22 is attached to the top of the housing 21. The operation panel 22 has two surfaces with one surface as a front surface and the opposite surface as a back surface. The operation panel 22 is attached to the housing 21 in such a manner that the front surface thereof faces the store clerk who stands on the floor surface 40. The operation panel 22 has a tilt structure capable of changing an angle of the front surface upwards.

On the front surface of the operation panel 22, a touch panel 23 and a keyboard 24 are arranged. As a result, the store clerk can touch the touch panel 23 or press each key on the keyboard 24. On the back surface of the operation panel 22, a display for customer 25 is attached. As a result, the customer going through the customer passageway can visually confirm information displayed on the display for customer 25.

The vertical scanner apparatus 20 has a fixed scanner 26 in the housing 21. In the vertical scanner apparatus 20, a reading window 27 is attached to a surface of the housing 21 facing the store clerk who stands on the floor surface 40. The reading window 27 has a tilt structure capable of changing an angle of the window downwards.

The fixed scanner 26 is a so-called optical mark reading device that optically scans and reads a barcode attached to a commodity. The fixed scanner 26 is provided with a laser light source and a light receiving element on a rear side of the reading window 27. The fixed scanner 26 emits light from the laser light source towards the reading window 27 while enable the laser light to scan a barcode. At this time, if the barcode attached to the commodity is held over the reading window 27, the reflected light of the laser light scanning the barcode reaches the light receiving element through the reading window 27. The fixed scanner 26 recognizes the barcode according to an amount of light received by the light receiving element. Thus, the store clerk holds the barcode attached to the commodity over the reading window 27, and in this way, the barcode is read by the fixed scanner 26. Moreover, since the reading window 27 has a tilt structure, by enabling the reading window 27 to direct downwards, a readable area by the fixed scanner 26 can be moved downwards.

The fixed scanner 26 may be a scanner using a CCD image sensor. Such a type of scanner can recognize the barcode by receiving and analyzing reflected light from the barcode with the CCD image sensor.

On the other hand, the touch panel 23 is provided for inputting information relating to a commodity to which no barcode is attached. Here, the fixed scanner 26 and the touch panel 23 function as the input device for receiving an input of the commodity information through an operation performed by the operator. Specifically, the fixed scanner 26 functions as a first input device for receiving input of the commodity information through an operation of holding the commodity over the reading window 27 including a reading surface. The touch panel 23 functions as a second input device for receiving input of the commodity information through a touch operation on an operation surface thereof.

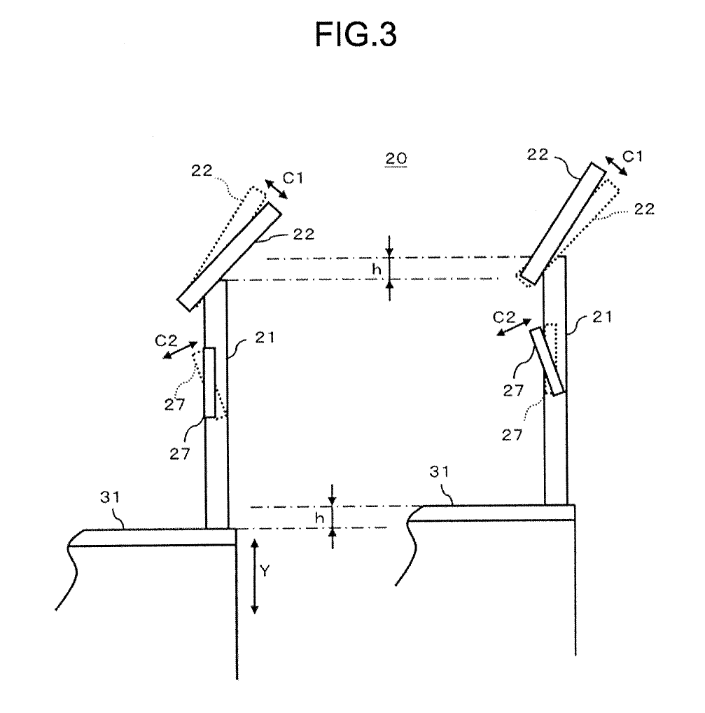

FIG. 3 is a schematic diagram illustrating a state of the vertical scanner apparatus 20. As described above, the housing 21 of the vertical scanner apparatus 20 is attached to the work table 31 that can be lifted and lowered in the Y direction in FIG. 3. Thus, for example, if the work table 31 is lifted or lowered by an amount h, the housing 21 also ascends or descends by the same amount h. As a result, the operation panel 22 and the reading window 27 attached to the housing 21 also ascend or descend by the same amount h.

As described above, the operation panel 22 can be manually tilted in a direction indicated by an arrow C1, and the reading window 27 can be tilted in a direction indicated by an arrow C2 in FIG. 3. Therefore, the store clerk who is the operator can adjust the angle of the operation panel 22 when an image on the touch panel 23 is difficult to see due to ambient light, for example. For example, the store clerk can tilt the reading window 27 downwards when holding a barcode attached to a heavy commodity over the reading window 27 to reduce a rising height of the commodity.

FIG. 4 is a block diagram illustrating a circuit configuration of main portions of the vertical scanner apparatus 20. In addition to the touch panel 23, the keyboard 24, the display for customer 25 and the fixed scanner 26, the vertical scanner apparatus 20 further includes a processor 201, a main memory 202, an auxiliary storage device 203, a clock 204, a communication interface 205, a lifting and lowering mechanism controller 206, a system bus 207, and the like. In the vertical scanner apparatus 20, the system bus 207 is connected to the processor 201, the main memory 202, the auxiliary storage device 203, the clock 204, the communication interface 205, the touch panel 23, the keyboard 24, the display for customer 25, the fixed scanner 26 and the lifting and lowering mechanism controller 206 directly or via a signal input/output circuit. In the vertical scanner apparatus 20, a computer includes the processor 201, the main memory 202, the auxiliary storage device 203, and the system bus 207 connecting them.

The processor 201 acts as a central part of the computer. The processor 201 controls each section to realize various functions of the vertical scanner apparatus 20 by executing an operating system and application programs.

The main memory 202 acts as a main memory portion of the computer. The main memory 202 includes a nonvolatile memory area and a volatile memory area. The main memory 202 stores the operating system and application programs in the nonvolatile memory area. The main memory 202 may store data necessary for the processor 201 to execute a processing to control each section in the nonvolatile or volatile memory area in some cases. The main memory 202 uses a volatile memory area as a work area where data is appropriately rewritten by the processor 201.

The auxiliary storage device 203 acts as an auxiliary storage portion of the computer. For example, the auxiliary storage device 203 may be an EEPROM (Electric Erasable Programmable Read-Only Memory), an HDD (Hard Disc Drive), an SSD (Solid State Drive), and the like. The auxiliary storage device 203 stores data used for the processor 201 to perform various processing and data generated in a processing executed by the processor 201. The auxiliary storage device 203 may store the above-described application program.

The clock 204 functions as a time information source of the vertical scanner apparatus 20. The processor 201 counts the time based on time information measured by the clock 204.

The communication interface 205 establishes data communication with a device connected thereto via the network 14 in conformity to a predetermined communication protocol.

The lifting and lowering mechanism controller 206 controls driving of the lifting and lowering mechanism 32 in response to a command from the processor 201 to lift or lower the work table 31.

The vertical scanner apparatus 20 having such a configuration can retrieve a store clerk database 50 via the communication interface 205. The store clerk database 50 stores various kinds of information relating to a store clerk in the retail store. The store clerk database 50 is stored in a storage device of the store server 13. The store clerk database 50 may be stored in a storage device of any one of the checkout apparatuses 12. Alternatively, a computer other than the store server 13 may be separately connected to the network 14, and the store clerk database 50 may be stored in a storage device of the computer.

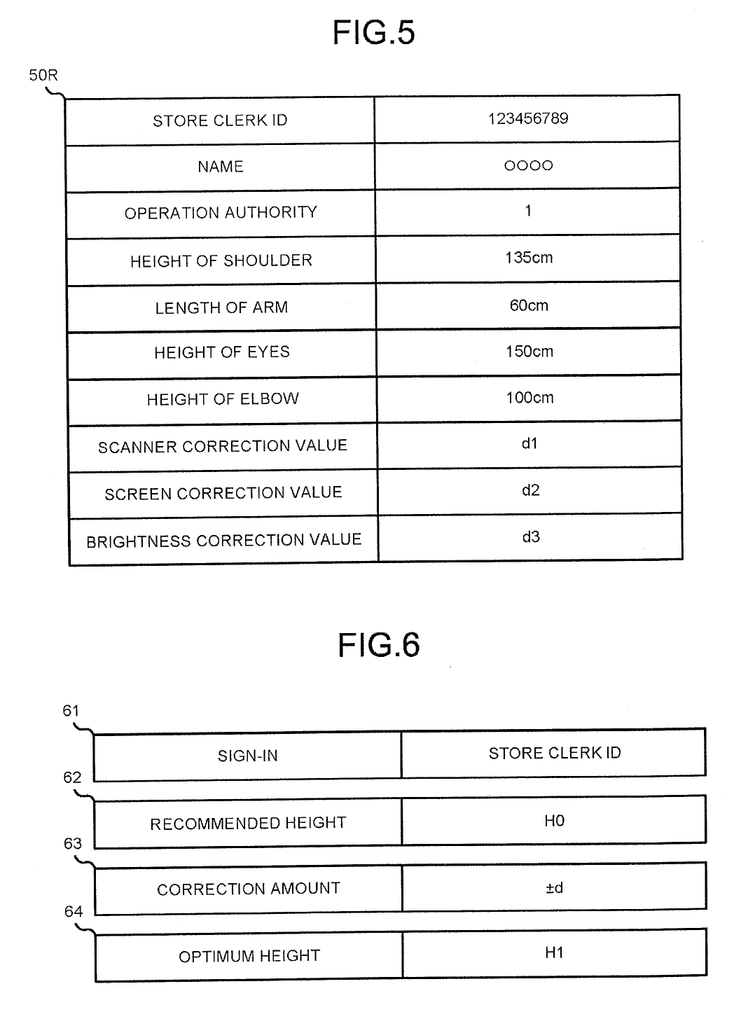

FIG. 5 is a schematic diagram illustrating a main data structure of a store clerk record 50R stored in the store clerk database 50. In the store clerk database 50, the store clerk record 50R created for each store clerk is stored.

As shown in FIG. 5, the store clerk record includes at least a store clerk ID, a name, an operation authority, a height of the shoulder, a length of the arm, a height of the eyes, a height of the elbow, a scanner correction value, a screen correction value and a brightness correction value. The store clerk ID is a unique code assigned to each store clerk to individually identify each store clerk. The name is a name of the store clerk identified by the store clerk ID, and the operation authority is information for determining whether or not the store clerk has authority to operate the vertical scanner apparatus 20.

The height of the shoulder, the length of the arm, the height of the eyes, and the height of the elbow are parameters of physical characteristics of the store clerk. The height of the shoulder, the eyes or the elbow is a height from the floor surface 40 to the shoulder, the eyes or the elbow when the store clerk stands upright on the floor surface 40. The length of the arm is a length from a joint of the shoulder to a fingertip of the store clerk.

The scanner correction value is a correction parameter based on an evaluation made by the store clerk on the operation of the fixed scanner 26. Similarly, the screen correction value and the brightness correction value are correction parameters based on an evaluation made by the store clerk on the operation of the touch panel 23.

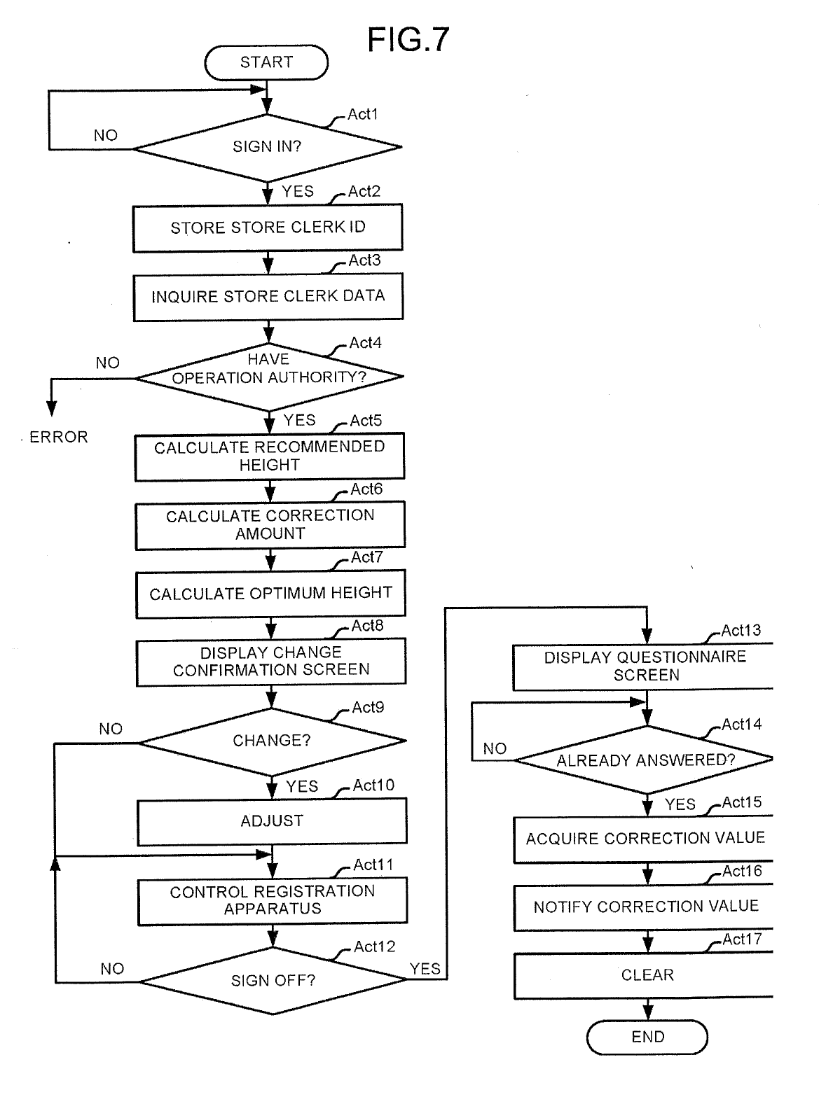

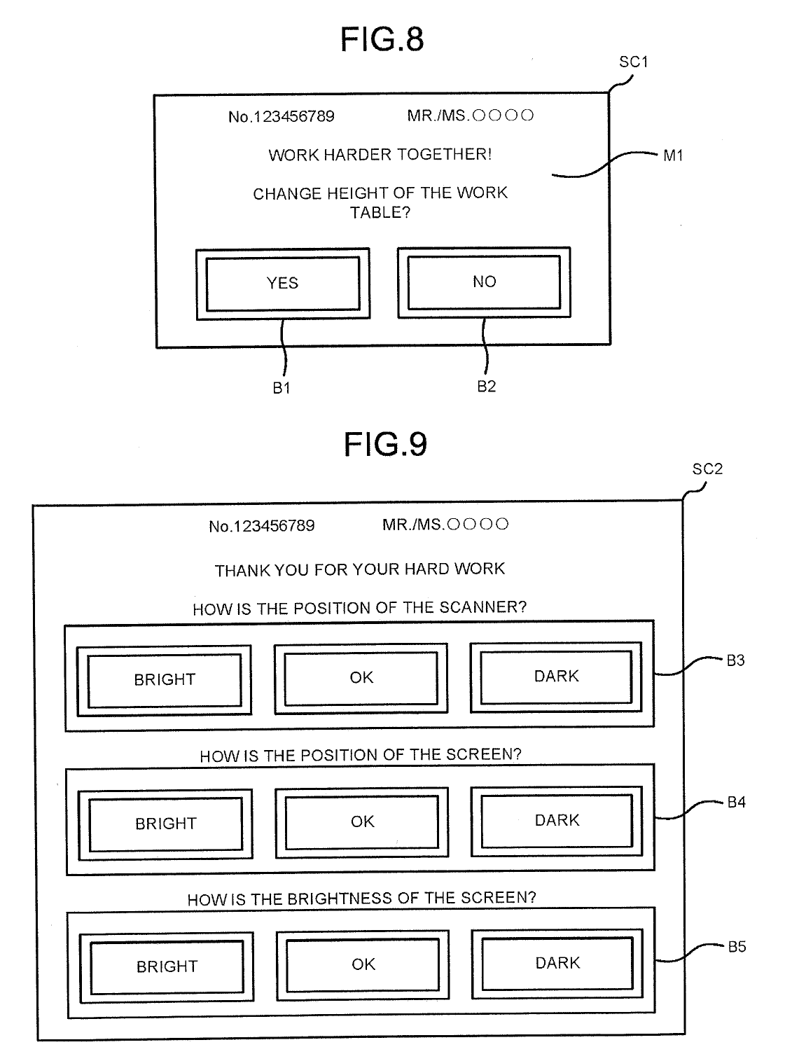

The vertical scanner apparatus 20 configured as described above has a function of adjusting a position of the input device so that the position thereof becomes ergonomically optimum position from the physical characteristics of the store clerk who is the operator to provide an optimum operation environment for each store clerk. In order to realize this function, as shown in FIG. 6, a volatile memory area in the main memory 202 of the vertical scanner apparatus 20 includes a sign-in memory 61, a recommended height memory 62, a correction amount memory 63 and an optimum height memory 64. The vertical scanner apparatus 20 stores, in the main memory 202 or the auxiliary storage device 203, a control program for enabling the computer with the processor 201 as the central part to execute an information processing having procedures shown in the flowchart in FIG. 7. FIG. 8 and FIG. 9 show examples of screens displayed on the touch panel 23 by the computer executing the above control program.

The operation of the vertical scanner apparatus 20 is described below with reference to FIG. 1 to FIG. 9. The contents of the processing described below are merely an example, and various processing capable of achieving the same results can be appropriately used.

First, the store clerk who starts operating the vertical scanner apparatus 20 performs a sign-in operation. For example, if the store clerk has an ID card printed with a barcode indicating the store clerk ID thereof, the store clerk presses a sign-in key on the keyboard 24, and then enables the fixed scanner 26 to read the barcode printed on the ID card. By doing so, the sign-in operation on the vertical scanner apparatus 20 is performed. The sign-in operation is not limited to the above example. For example, the sign-in operation may be realized by inputting a store clerk ID with numeric keys on the keyboard 24 and then pressing the sign-in key.

The processor 201 of the vertical scanner apparatus 20 in which the control program is started stands by until the sign-in operation is performed in Act 1. Then, if it is detected that the sign-in operation is performed as described above (Yes in Act 1), the processor 201 writes the store clerk ID input through the sign-in operation to the sign-in memory 61 in Act 2.

Here, the computer with the processor 210 as the central part functions as an identifying module which identifies the operator by executing the processing in Act 1 and Act 2.

The processor 201 generates an inquiry command about store clerk data in Act 3. Then, the processor 201 controls the communication interface 205 to transmit the inquiry command to, for example, the store server 13 which is a device managing the store clerk database 50. Under the control, the inquiry command is transmitted from the communication interface 205 to the store server 13 via the network 14. The inquiry command includes the store clerk ID stored in the sign-in memory 61. As a result, the store server 13 extracts a store clerk record 50R including the store clerk ID from the store clerk database 50, and then transmits the store clerk record 50R to the vertical scanner apparatus 20 transmitting the inquiry command via the network 14.

The processor 201 of the vertical scanner apparatus 20 transmitting the inquiry command stands by until the store clerk record 50R is received. If the processor 201 receives the store clerk record 50R via the communication interface 205, the processor 201 examines operation authority information in the store clerk record 50R in Act 4. If the store clerk does not have the operation authority of the vertical scanner apparatus 20, the operation authority information indicates that there is no operation authority. In this case (No in Act 4), the processor 201 sets the sign-in operation as an error.

If the store clerk has the operation authority of the vertical scanner apparatus 20, the operation authority information indicates that there is the operation authority. In this case (Yes in Act 4), the processor 201 calculates a recommended height from a reference plane (floor surface 40) of the input device (the touch panel 23 and the fixed scanner 26) based on the parameters relating to the physical characteristics included in the store clerk record 50R in Act 5. In the present embodiment, the parameters indicating the physical characteristics include the height of the shoulder, the length of the arm, the height of the eyes, and the height of the elbow of the store clerk. Based on these values, the processor 201 calculates the height from the reference plane which is an ergonomically comfortable environment for the operation of touching the touch panel 23 and the operation of holding the commodity over the reading window 27 executed by the store clerk.

More specifically, it is assumed that the ergonomically optimum height is set as P1 for the operation of touching the touch panel 23 by the store clerk having the physical characteristics set in the store clerk record 50R. The ergonomically optimum height is set as P2 for the operation of holding the commodity over the reading window 27 by the same store clerk. In that case, the processor 201 calculates an average value “(P1+P2)/2” of the height P1 and the height P2 as a recommended height H0 from the reference plane of the input device. The processor 201 writes the recommended height H0 from the reference plane to the recommended height memory 62.

Here, based on the parameters relating to the physical characteristics set for the operator identified by the identifying module, the computer with the processor 201 as the central part functions as a calculation module for calculating the recommended height H0 from the reference plane to the input device through the processing in Act 5.

In Act 6, the processor 201 calculates a correction amount of the recommended height based on the correction parameters included in the store clerk record 50R. The correction parameters include a scanner correction value d1, a screen correction value d2 and a brightness correction value d3. The processor 201 sets a sum “d1+d2+d3” of the scanner correction value d1, the screen correction value d2 and the brightness correction value d3 as a correction amount±d, for example. Alternatively, the processor 201 may multiply the scanner correction value d1, the screen correction value d2 and the brightness correction value d3 by predetermined coefficients α1, α2 and α3, respectively, and then set a sum “d1*α1+d2*α2+d3*α3” of a the scanner correction value “d1*α1”, the screen correction value “d2*α2” and the brightness correction value “d3*α3” after multiplying the respective coefficients as the correction amount±d. The processor 201 writes the correction amount±d to the correction amount memory 63.

The processor 201 calculates an optimum height H1 from the reference plane to the input device in Act 7. Specifically, the processor 201 calculates the optimum height H1 by correcting the recommended height H0 stored in the recommended height memory 62 with the correction amount±d acquired from the correction amount memory 63. The processor 201 writes the optimum height H1 to the optimum height memory 63.

Here, the computer with the processor 201 as the central part functions as a correction module for correcting the recommended height using the parameters based on the evaluation obtained by an acquisition module through the processing in Act 6 and Act 7. The acquisition module is described later.

If the optimum height H1 from the reference plane to the input device is calculated in this way, the processor 201 controls the touch panel 23 to display a change confirmation screen SC1 (refer to FIG. 8) in Act 8.

FIG. 8 is a schematic diagram illustrating an example of the change confirmation screen SC1. As shown in FIG. 8, the change confirmation screen SC1 includes a message M1 for inquiring the store clerk who is an operator about whether to change the height of the work table 31, and button images of a “Yes” button B1 and a “NO” button B2.

If the store clerk who confirms the change confirmation screen SC1 wants to change the height of the work table 31 so that the height of the touch panel 23 and the reading window 27 from the floor surface 40 becomes the optimum height for himself/herself, the store clerk touches the “Yes” button B1. In a case of not changing the height, the store clerk touches the “No” button B2.

The processor 201 displaying the change confirmation screen SC1 on the touch panel 23 stands by until the “Yes” button B1 is touched or the “No” button B2 is touched in Act 9.

If the “Yes” button B1 is touched (Yes in Act 9), the processor 201 adjusts the height of the work table 31 according to the optimum height H1 stored in the optimum height memory 64 in Act 10. Specifically, the processor 201 sets half of a distance from the center of the reading window 27 to the top of the housing 21 as a reference position of the height of the input device. Then, the height of the work table 31 from the floor surface 40 is determined so that the distance from the floor surface 40 to the reference position is equal to the optimum height H1. Specifically, since a length L1 from the reference position to the upper surface of the work table 31 is fixed, a value “H1−L1” obtained by subtracting the length L1 from the optimum height H1 is determined as the height of the work table 31 from the floor surface 40. The processor 201 controls the lifting and lowering mechanism controller 206 in such a manner that the height of the work table 31 from the floor surface 40 is equal to the determined height “H1−L1”. Under the control, the lifting and lowering mechanism 32 operates to lift or lower the work table 31 to a position where the height from the floor surface 40 becomes the determined height “H1−L1”.

Here, the computer with the processor 201 as the central part functions as an adjustment module for adjusting the position of the input device so that the height from the reference plane to the input device is equal to the recommended height corrected by the correction module through the processing in Act 10.

If the “No” button B2 is touched in the change confirmation screen SC1 (No in Act 9), the processor 201 does not execute the processing in Act 10.

In the change confirmation screen SC1, if the “No” button B2 is touched or the “Yes” button B1 is touched and the processing in Act 10 is terminated, the processor 201 controls each section so that the vertical scanner apparatus 20 functions as the registration apparatus 11 in Act 11. Such a control operation includes a control operation of adding information such as a commodity name, a unit price, a sales quantity, selling price, etc. of a commodity specified by a barcode to a purchase list by reading the barcode attached to the commodity held over the reading window 27 with the fixed scanner 26. Such a control operation includes a control operation of adding information such as a commodity name, a unit price, a sales quantity, selling price, etc. of a commodity selectively input through a touch operation on the touch panel 23 to a purchase list. Such a control operation further includes a control operation of transmitting a purchase list to the checkout apparatus 12 via the network 14.

The processor 201 determines whether or not a sign-off operation is performed in Act 12. If the sign-off operation is not performed (No in Act 12), the processor 201 continues the control operation of the vertical scanner apparatus 20 as the registration apparatus 11.

The store clerk who terminates the operation of the vertical scanner apparatus 20 performs the sign-off operation. For example, a sign-off key arranged on the keyboard 24 is pressed. By doing so, the sign-off operation is performed on the vertical scanner apparatus 20. The sign-off operation is not limited to the above example.

If the sign-off operation is performed in Act 12 (Yes in Act 12), the processor 201 displays a questionnaire screen SC2 (refer to FIG. 9) on the touch panel 23 in Act 13.

FIG. 9 is a schematic diagram illustrating an example of the questionnaire screen SC2. As shown in FIG. 9, on the questionnaire screen SC2, questionnaire items for the store clerk who terminates the operation of the vertical scanner apparatus 20 and answer buttons B3, B4 and B5 thereof are displayed. In the example in FIG. 9, a questionnaire item about the position of the fixed scanner 26 and its answer button B3, a questionnaire item about the position of the touch panel 23 and its answer button B4, and a questionnaire item about the brightness of the touch panel 23 and its answer button B5 are displayed.

The store clerk who confirms the questionnaire screen SC2 determines whether the position of the fixed scanner 26 is OK, high or low. Then, the store clerk touches the corresponding button in the answer button B3. The store clerk determines whether the height of the screen of the touch panel 23 is OK, high or low. Then, the store clerk touches the corresponding button in the answer button B4. The store clerk determines whether the brightness of the screen of the touch panel 23 is OK, too bright, or too dark. Then, the store clerk touches the corresponding button in the answer button B5. The order of answering the questionnaire items is not particularly limited.

The processor 201 controlling display of the questionnaire screen SC2 stands by until all the questionnaire items are answered in Act 14. If the answer buttons B3, B4 and B5 are respectively touched, the processor 201 determines that all the questionnaire items are answered. If all the questionnaire items are answered (Yes in Act 14) , the processor 201 acquires a correction value according to the answer result in Act 15. Specifically, if “OK” is touched in the answer button B3, “0” is acquired as the scanner correction value; if “high” is touched, “−1” is acquired as the scanner correction value; and if “low” is touched, “+1” is acquired as the scanner correction value. Similarly, if “OK” is touched in the answer button B4, “0” is acquired as the screen correction value; if “high” is touched, “−1” is acquired as the screen correction value; and if “low” is touched, “+1” is acquired as the screen correction value. If “OK” is touched in the answer button B5, “0” is acquired as the brightness correction value; if “bright” is touched, “−1” is acquired as the brightness correction value; and if “dark” is touched, “+1” is acquired as the brightness correction value.

Here, the computer with the processor 201 as the central part constitutes an acquisition module for acquiring an evaluation of the operator on the operation on the input device through the processing in Act 13 to Act 15.

The processor 201 generates a notification command of the correction value acquired in Act 15 in Act 16. Then, the processor 201 controls the communication interface 205 to transmit the notification command, for example, to the store server 13 which is a device managing the store clerk database 50. Under the control, the notification command is transmitted from the communication interface 205 to the store server 13 via the network 14. The notification command includes the store clerk ID stored in the sign-in memory 61, and the scanner correction value, the screen correction value and the brightness correction value, which are acquired in Act 15. As a result, in the store server 13, the store clerk record 50R including the store clerk ID is extracted from the store clerk database 50. The scanner correction value, the screen correction value and the brightness correction value included in the notification command are respectively added to the scanner correction value, the screen correction value and the brightness correction value in the store clerk record 50R. The store clerk record 50R in which the correction values are updated is overwritten and is then stored in the store clerk database 50.

The processor 201 transmitting the notification command clears the sign-in memory 61, the recommended height memory 62, the correction amount memory 63 and the optimum height memory 64 in Act 17. Thus, the processor 201 terminates the information processing realized by executing the control program.

As described above, in the vertical scanner apparatus 20 of at least one embodiment, the height of the work table 31 is automatically adjusted so as to be an optimum position from ergonomic detection based on the parameters indicating physical characteristics of the store clerk for the operation of touching the touch panel 23 or holding the commodity over the reading window 27. Here, the parameters indicating the physical characteristics include the height of the shoulder, the length of the arm, the height of the eyes, and the height of the elbow, and the above information are stored in the store clerk database 50 in advance. Therefore, according to the present embodiment, it is possible to reliably realize an optimum operation environment for the store clerk without increasing burden on the store clerk.

In the vertical scanner apparatus 20, the change confirmation screen SC1 is displayed on the touch panel 23 in conjunction with the sign-in operation performed by the store clerk. Then, if the “Yes” button B1 on the change confirmation screen SC1 is touched, the height of the work table 31 is adjusted. On the other hand, if the “No” button B2 is touched, the height of the work table 31 is not adjusted. Therefore, according to at least one embodiment, whether to adjust the height of the work table 31 can be determined for each store clerk.

In the vertical scanner apparatus 20, the questionnaire screen SC2 is displayed on the touch panel 23 in conjunction with the sign-off operation performed by the store clerk. For the questionnaire items relating to the height of the reading window 27 from the floor surface 40, the height of the touch panel 23 from the floor surface 40, and the brightness of the touch panel 23, the evaluation of the store clerk is obtained. The evaluation information is used as the correction value in the adjustment of the height of the work table 31. Therefore, according to the present embodiment, while considering the evaluation of the store clerk, it is possible to reliably realize an optimum operation environment for that store clerk.

### Second Embodiment

In the first embodiment, the reference position of the height of the input device is set to half of the distance from the center of the reading window 27 to the top of the housing 21. This is determined based on the consideration that the operation on the touch panel 23 and the operation on the fixed scanner 26 are performed at the same level. However, for example, there is a retail store which sells vegetables without a barcode without any change during the daytime, but at night, processes the vegetables and attaches a barcode to the vegetables as prepared food. In such a store, it is considered that the operation on the touch panel 23 is frequent during the daytime and is not frequent at night. Therefore, a vertical scanner apparatus 20 which can surely realize the optimum operation environment for the store clerk in consideration of the case in which the operation on the touch panel 23 varies depending on a time period is described as the second embodiment.

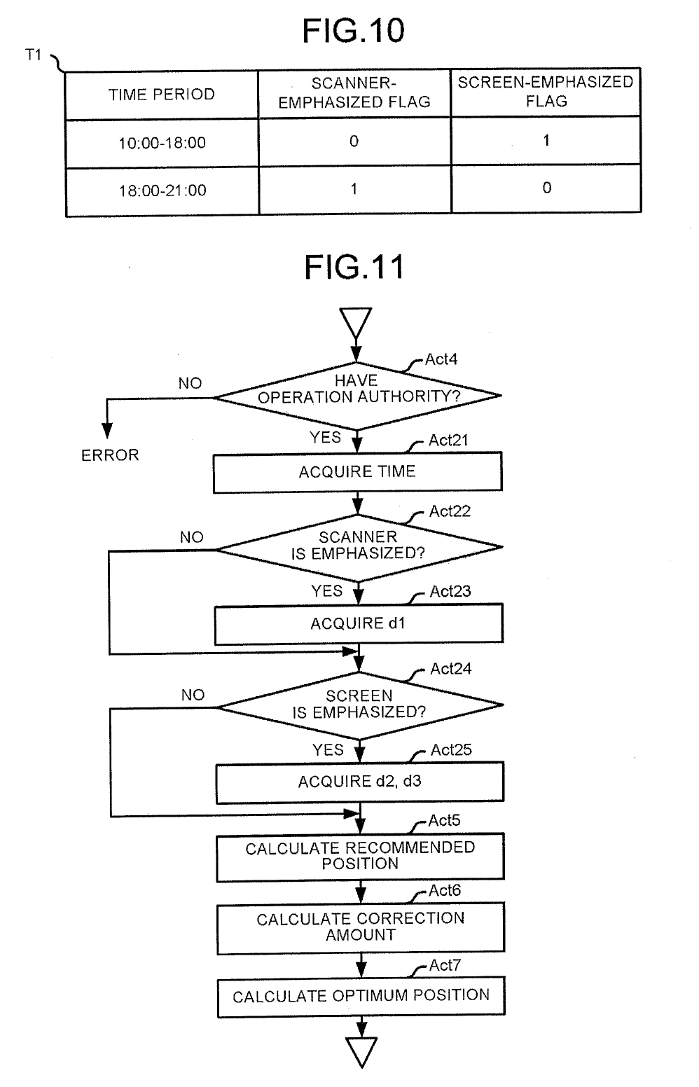

The second embodiment is different from the first embodiment in that a setting table T1 shown in FIG. 10 is stored in the auxiliary storage device 203 and in a part of the processing realized by the processor 201 executing the control program. Except for the above differences, the second embodiment is the same as the first embodiment, and thus, FIG. 1 to FIG. 9 are adopted without any change, the same components are denoted by the same reference numerals, and a detailed description thereof is omitted.

As shown in FIG. 10, the setting table T1 stores a scanner-emphasized flag and a screen-emphasized flag in association with each time period between the daytime (10:00-18:00) and a nighttime (18:00-21:00). The scanner-emphasized flag is set to “1” when the fixed scanner 26 is emphasized with respect to the touch panel 23. The screen-emphasized flag is set to “1” when the touch panel 23 is emphasized with respect to the fixed scanner 26. In other words, when the operation on the touch panel 23 is frequent during the daytime and is not frequent during the nighttime, the screen-emphasized flag associated with the time period indicating daytime (10:00-18:00) is set to “1”, and the scanner-emphasized flag associated with the time period indicating nighttime (18:00-21:00) is set to “1”.

FIG. 11 shows a part of a flowchart including procedures different from those in the first embodiment among the processing realized by the processor 201 executing the control program. The second embodiment is different from the first embodiment in that the processing in Act 21 to Act 25 is executed between the processing in Act 4 and Act 5.

Specifically, if the store clerk has the operation authority of the vertical scanner apparatus 20 (Yes in Act 4), the processor 201 acquires the current time counted by the clock 204 in Act 21.

Next, the processor 201 refers to the setting table T1 to determine whether or not the scanner-emphasized flag associated with the time period including the current time is set to “1” in Act 22. If the scanner-emphasized flag is set to “1” (Yes in Act 22), the processor 201 acquires the scanner correction value d1 from the store clerk record 50R in Act 23. If the scanner-emphasized flag is not set to “1” (No in Act 22), the processor 201 does not acquire the scanner correction value d1.

Next, the processor 201 refers to the setting table T1 to determine whether or not the screen-emphasized flag associated with the time period including the current time is set to “1” in Act 24. If the screen-emphasized flag is set to “1” (Yes in Act 24), the processor 201 acquires the screen correction value d2 and the brightness correction value d3 from the store clerk record 50R in Act 25. If the screen-emphasized flag is not set to “1” (No in Act 24), the processor 201 does not acquire the screen correction value d2 and the brightness correction value d3.

Here, the computer with the processor 201 as the central part constitutes a determination module for determining whether to give priority to the operation on the first input device or the operation on the second input device by the processing in Act 22 and Act 24.

Thereafter, the processor 201 executes the processing subsequent to Act 5 in the same manner as in the first embodiment. Therefore, in Act 6, the processor 201 sets the scanner correction value d1 as the correction amount±d in a time period in which the scanner-emphasized flag is set to “1”. Alternatively, the scanner correction value “d1*α1” obtained by multiplying the scanner correction value d1 by the predetermined coefficient α1 maybe set as the correction amount±d.

Similarly, in the time period in which the screen-emphasized flag is set to “1”, the processor 201 sets the sum “d2+d3” of the screen correction value d2 and the brightness correction value d3 as the correction amount±d. Alternatively, the sum “d2*α2+d3*α3” of the screen correction value “d2*α2” and the brightness correction value “d3*α3” obtained by multiplying the screen correction value d2 and the brightness correction value d3 by predetermined coefficients α2 and α3 may be set as the correction amount±d.

In the time period in which both the scanner-emphasized flag and the screen-emphasized flag are set to “1”, as in the first embodiment, the sum “d1+d2+d3” of the scanner correction value d1,the screen correction value d2 and the brightness correction value d3 is set as the correction amount±d. Alternatively, the sum “d1*α1+d2*α2+d3*α3” of the scanner correction value “d1*α1”, the screen correction value “d2*α2” and the brightness correction value “d3*α3” obtained by multiplying the coefficients α1, α2 and α3 may be set as the correction amount±d.

In the time period during which both the scanner-emphasized flag and the screen-emphasized flag are reset to “0”, the correction amount±d is “0”.

As described above, in the vertical scanner apparatus 20 of the second embodiment, the work table 31 is positioned at a position where the operation environment for the touch panel 23 is optimum in the time period in which an operation frequency of the touch panel 23 is high. In the time period in which an operation frequency of the fixed scanner 26 is high, the work table 31 is positioned at a position where the operation environment for the fixed scanner 26 is optimum. Therefore, even when the operation frequencies of the touch panel 23 and the fixed scanner 26 vary depending on the time period, it is possible to reliably realize the optimum operation environment for the store clerk at all times.

Although the first embodiment and the second embodiment have been described as the embodiments of the commodity information input apparatus, the embodiments are not limited thereto, and various modifications can be made. Below, other embodiments are briefly described.

In the above embodiments, the evaluation for the operation on the input device made by the operator is acquired, and the recommended height is corrected using the parameters based on the evaluation. In other embodiments, the position of the input device may be adjusted so that the height from the reference plane to the input device is equal to the recommended height without acquiring the evaluation for the operation on the input device made by the operator. In this case, the scanner correction value, the screen correction value and the brightness correction value from the store clerk record 50R can be omitted. In the flowchart in FIG. 7, the processing in Act 6, Act 7 and Act 13 to Act 16 can be omitted.

In the above embodiments, the fixed scanner 26 and the touch panel 23 are exemplified as the input devices of the commodity information input apparatus. The input device is not limited thereto. Instead of the fixed scanner 26, for example, an image capturing device for capturing an external appearance of the commodity may be used. In this case, the commodity information input apparatus recognizes a commodity from a feature amount of the captured image of the external appearance. Instead of the touch panel 23, a keyboard may be used. Furthermore, either the fixed scanner 26 or the touch panel 23 may be used.

In the above embodiments, the parameters indicating the physical characteristics include the height of the shoulder, the length of the arm, the height of the eyes and the height of the elbow of the store clerk. The parameters are not limited to these. At least one of these values may be used as the parameter. Alternatively, a combination of at least one of these values and another value may be used as the parameter.

In the second embodiment, it is determined whether to give priority to the operation on the first input device or the operation on the second input device according to the time period. In another embodiment, it is determined whether to give priority to the operation on the first input device or the operation on the second input device according to elements such as date, day of the week, week, month, etc. instead of the time period.

The lifting and lowering mechanism 32 may only lift or lower the checkout counter 30 instead of listing or lowering the work table 31.

In the above embodiments, the height of the input device is adjusted with the sign-in operation performed by the store clerk as a trigger. The trigger is not limited to the sign-in operation. For example, if a predetermined key operation is executed, the height of the input device may be adjusted with the predetermined key operation as the trigger. Similarly, in the above embodiments, the questionnaire screen SC2 is displayed on the touch panel 23 with the sign-off operation performed by the store clerk as a trigger. The trigger is not limited to the sign-off operation. For example, when a predetermined key is operated, the questionnaire screen SC2 may be displayed on the touch panel 23 with the predetermined key operation as the trigger.

In above embodiments, the vertical scanner apparatus 20 functioning as the registration apparatus 11 in the semi-self-service type POS system is exemplified as the commodity information input apparatus. The commodity information input apparatus is not limited to the vertical scanner apparatus 20 functioning as the registration apparatus 11. For example, it may be a face-to-face type POS terminal, the vertical scanner apparatus, or a self-service type POS terminal.

The commodity information input apparatus is generally transferred with a program such as a control program stored in the main memory 202 or the auxiliary storage device 203. However, it is not limited thereto, and the commodity information input apparatus may be transferred in a state in which the program is not stored in the main memory 202 or the auxiliary storage device 203. In this case, the control program transferred independently of the commodity information input apparatus may be written in a writable storage device of the commodity information input apparatus in response to an operation performed by a user or the like. The control program can be transferred by being recorded on a removable recording medium or by communication via a network. The recording medium may be in any form as long as it can store the program and is readable by the apparatus, such as a CD-ROM, a memory card, etc. The function obtained by installing or downloading the program may be realized by cooperation of the program with an OS (operating system) in the apparatus.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A commodity information input apparatus, comprising:
an input device configured to receive input of commodity information through an operation executed by an operator; and
a computer configured to:
identify the operator;
calculate a recommended height from a reference plane to the input device based on parameters relating to physical characteristics set for the operator identified by the computer; and
adjust a position of the input device so that a height from the reference plane to the input device is equal to the recommended height calculated by the computer.

2. The commodity information input apparatus according to claim 1, wherein the physical parameters include at least one of a shoulder height, an arm length, an eye height, or an elbow height of the operator.

3. The commodity information input apparatus according to claim 1, wherein the parameters relating to physical characteristics set for the operator are stored in a database external to the computer.

4. The commodity information input apparatus according to claim 1, wherein the computer is further configured to:
acquire an evaluation on the operation on the input device made by the operator; and
correct the recommended height using parameters based on the evaluation obtained by the computer, wherein
the computer is configured to adjust the position of the input device so that the position of the input device is equal to a recommended height corrected by the computer.

5. The commodity information input apparatus according to claim 4, wherein
the input device comprises a first input device configured to receive input of the commodity information through an operation of holding a commodity over a reading surface and a second input device configured to receive input of the commodity information through a touch operation on an operation surface, and
the computer is configured to acquire an evaluation on an operation on the first input device and an evaluation on an operation on the second input device, which are made by an operator.

6. The commodity information input apparatus according to claim 5, wherein the computer is further configured to:
determine whether to give priority to the operation on the first input device or the operation on the second input device, and
correct the recommended height using parameters based on the evaluation for the operation on the first input device made by an operator when the computer determines that the operation on the first input device is prioritized, and correct the recommended height using parameters based on the evaluation for the operation on the second input device made by an operator when the computer determines that the operation on the second input device is prioritized.

7. The commodity information input apparatus according to claim 6, wherein
the computer is configured to determine whether to give priority to the operation on the first input device or the operation on the second input device according to a time period.

8. The commodity information input apparatus according to claim 7, wherein the time period is a time of day.

9. A method of operating a commodity information input apparatus including an input device configured to receive input of commodity information through an operation executed by an operator, the method comprising:
identifying the operator;
calculating a recommended height from a reference plane to the input device based on parameters relating to physical characteristics set for the identified operator; and
adjusting a position of the input device so that a height from the reference plane to the input device is equal to the calculated recommended height.

10. The method according to claim 9, wherein the physical parameters include at least one of a shoulder height, an arm length, an eye height, or an elbow height of the operator.

11. The method according to claim 9, wherein the parameters relating to physical characteristics set for the operator are stored in an external database.

12. The method according to claim 9, further comprising:
acquiring an evaluation on an operation on the input device made by the operator; and
correcting the recommended height using parameters based on the obtained evaluation, wherein
the position of the input device is adjusted so that the position of the input device is equal to a corrected recommended height.

13. The method according to claim 12, wherein
the input device comprises a first input device configured to receive input of the commodity information through an operation of holding a commodity over a reading surface and a second input device configured to receive input of the commodity information through a touch operation on an operation surface, wherein the method further comprising acquiring an evaluation on an operation on the first input device and an evaluation on an operation on the second input device, which are made by an operator.

14. The method according to claim 13, further comprising:
determining whether to give priority to the operation on the first input device or the operation on the second input device, and
correcting the recommended height using parameters based on an evaluation for the operation on the first input device made by an operator when the computer determines that the operation on the first input device is prioritized, and correcting the recommended height using parameters based on an evaluation for the operation on the second input device made by an operator when the computer determines that the operation on the second input device is prioritized.

15. The method according to claim 14, further comprising determining whether to give priority to the operation on the first input device or the operation on the second input device according to a time period.

16. The method according to claim 15, wherein the time period is a time of day.
